(19) United States
(12) Patent Application Publication
(10) Pub. No.: US 2019/0066415 A1
(43) Pub. Date: Feb. 28, 2019

(54) MOBILE-BASED ACCESS CONTROL SYSTEM

(71) Applicant: Timetec Holding Sdn Bhd, PUCHONG (MY)

(72) Inventors: KOK LOONG PANG, Puchong (MY); HON SENG TEH, Puchong (MY)

(73) Assignee: Timetec Holding Sdn Bhd, PUCHONG (MY)

(21) Appl. No.: 16/059,537

(22) Filed: Aug. 9, 2018

(30) Foreign Application Priority Data
Aug. 28, 2017 (MY) PI 2017703168

(51) Int. Cl. G07C 9/00; H04L 29/08

(52) U.S. Cl. CPC G07C 9/00087; G07C 9/00111; G07C 9/00563; H04W 4/80; G07C 2009/00095; G07C 2209/04; H04L 67/125

(57) ABSTRACT

A control system for door lock includes a server, a controller linked to the server and a mobile device having an application for a user to trigger a door unlocking process, means for collecting biometric information of the user, a BLUETOOTH module to establish a BLUETOOTH communication link between the mobile device and the controller, and wherein the door unlocking process includes the mobile device performing a biometric authentication to verify the user and then transmitting an instruction to the controller via the BLUETOOTH link, and the controller, upon receiving the instruction, performs a second authentication to verify the user's accessibility and then unlock the door based on the outcomes of the authentications.

### CROSS-REFERENCE TO RELATED APPLICATION

The instant application claims priority to Malaysia Patent Application Ser. No. PI 2017703168 filed Aug. 28, 2017, the entire specification of which is expressly incorporated herein by reference.

### FIELD OF THE INVENTION

The invention relates to a door access system. More particularly, the invention relates to a wireless door access system using mobile device and method thereof.

### BACKGROUND OF THE INVENTION

Over the years, traditional lock system or digital lock system has been applied for high security areas or in locker rooms for buildings. Drawbacks were found within these systems whereby the buildings are not perfectly secured. With the advancements of technology, RFID cards were introduced to replace the traditional keys. This system requires the users to wear or carry identification badges for building access, which are either inspected by security guard or are read by machines installed at the access doors. Nevertheless, these cards were not effective enough due to the possibility of getting lost, stolen and forgotten.

There are a few patented technologies regarding the aforementioned door access system. Of interest in respect to a wireless access control system is disclosed in US 2013/0237193, this patent provides guidance on a wireless access control system includes a remote access device. A plugin device communicates with the remote access device. A lock controls the ability to lock and unlock a door in which the lock is disposed. The lock is in communication with the plug in device. The plug in device determines a distance between the remote access device and the lock and causes the lock to communicate with the remote access device when the remote access device is at a distance less than or equal to a predetermined distance from the lock to enable the lock to be unlocked. Nonetheless, the disclosed invention does not include security features such as password during the unlock operation.

Besides, U.S. Pat. No. 9,353,551 discloses a wireless door locking system including a door lock having a locking device, a sensor and a microcontroller. The system also includes a mobile computing device having a display and a mobile application, wherein the mobile computing device is place proximate to the door lock. The system includes a server in communication with the mobile computing device. The mobile application may generate a code such as a light pattern in response to communication with the server and transmits the light pattern from the display. The controller of the door lock disengages the locking device in response to the sensor receiving the generated code communicated from the mobile computing device and determining that the generated code includes correct data to disengage the locking device of the door lock. However, the drawback of this system is that the accessibility of user is not updateable in real time such that certain user can only grant access at a predetermined time.

In a nut shell, it is essential to provide a door access control system which can overcome the aforementioned drawbacks. This invention provides such a system and method.

### SUMMARY OF THE INVENTION

The main objective of the invention is to provide users a system for controlling the operation of door entrance wirelessly and also to enhance the security protection of the door entrance. To achieve this objective, the invention provides a control system for door lock comprising a server, a controller for unlocking the door and a mobile device having an application for user to trigger a door unlocking process, means for collecting biometric information of the user, a BLUETOOTH module to establish a BLUETOOTH communication link between the mobile device and the controller, wherein the controller is linked to the server to receive updates on user access credentials, and wherein door unlocking process includes the mobile device firstly performs a biometric authentication to verify the user and then transmit an instruction to the controller via the BLUETOOTH communication link and the controller upon receiving the instruction, performs a second authentication to verify the user's accessibility based on the received user access credentials and then unlock the door based on the outcomes of the authentications.

By BLUETOOTH, as that term is used herein, it is meant to include, without limitation, any wireless technology standard for exchanging data over short distances using short-wavelength UHF radio waves in the ISM band from 2.4 to 2.485 GHz) from fixed and mobile telecommunication devices, and building personal area networks (PANs).

Preferably, the updates of user access credentials include user ID, date, time and controller pairing code.

Preferably, the controller performs the second authentication by checking the user's ID within a timeframe with the pre-stored authorized users' ID list before the door access could be granted.

Preferably, the server stores the user's access credentials.

Preferably, the server further processes the user's access credentials for the door unlocking process.

Alternately, the controller couples with an electronic door system and sensors for controlling the operation of the door.

Preferably, the controller tracks and reports door status to the server.

Preferably, the mobile device application receives user's access credentials from the server to perform local authentication.

Alternately, the biometric data collecting means is in the form of fingerprint sensor, face recognition sensor, iris sensor, body posture sensor or in any combination thereof.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a chart illustrating the components of the door access system.

FIG. 2 is a flowchart illustrating the administration operation of the system.

FIG. 3 is a flowchart illustrating the flow automation of a BLUETOOTH Access Controller for door access control.

FIG. 4 is a flowchart illustrating the user operation of the system.

### DETAILED DESCRIPTION OF THE INVENTION

The invention will now be described in greater detail, by way of example, with reference to the drawings.

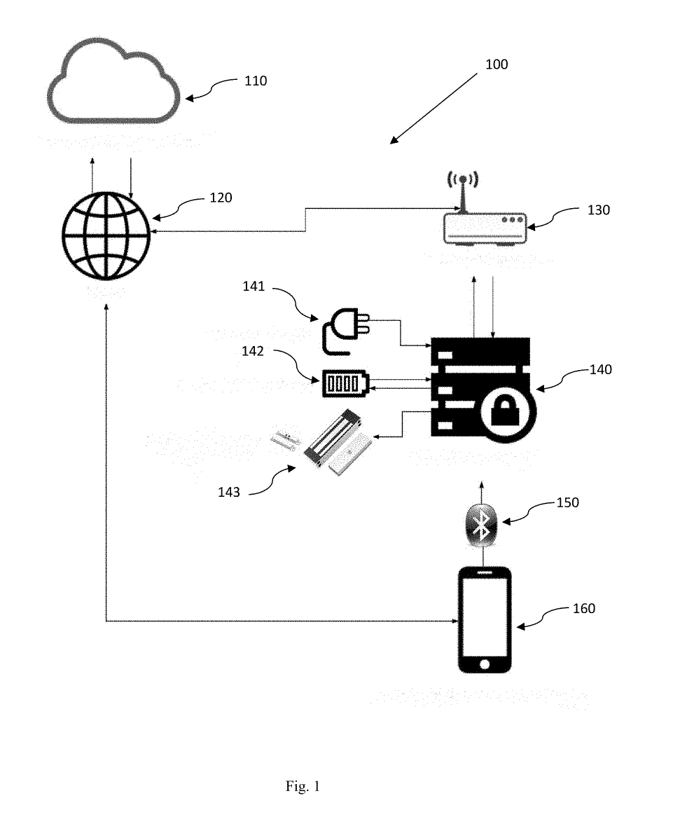

FIG. 1 illustrates the mobile-based door access system 100. The system 100 includes a cloud base server 110, at least one mobile device 160 installed with a mobile application, and a controller 140 installed at the door entrance, wherein the controller includes means for power supply 141, a rechargeable backup battery 142 and an electronic door lock with magnetic sensors 143. The cloud base server 110 is setup for different groups of users to register an account. Individual group administrator may login to the system 100 by using a unique login credentials to create and manage the controller 140, user's credentials, and permitted access times. The term “administrator” is referred to a person who modify the grant of access of door entrance in the cloud base server 110 whereas the term “user” is referred to a person who performs unlocking of door entrance using a mobile device 160. The mobile application will require the user to establish a network connection to the cloud base server 110 for downloading the data from the cloud base server 110 for authentication purpose.

Preferably, the mobile device 160 includes a display unit, biometric sensors and a transceiver. The mobile application downloads user's access credential data from cloud base server 110, wherein the user's access credential data includes user's authentication data, user's door entrance accessibility, and accessible date and time. The application further processes the data and reflects the doors allow to access on handheld device's display unit to alert the user. The application installed on the handheld device 160 allows the user to send user ID, date, time and controller 140 pairing code to the controller 140 via BLUETOOTH connection 150. The controller 140 validates the data by internal memory (current date, time and user ID) as second security layer. The controller 140 then sends signal to unlock door when data is validated. All the entry-exit records will be sent to the cloud base server 110 by the controller 140 via internet connection. Preferably, the controller 140 is connected to a network router or modem 130 for internet accessibility with the cloud base server 110.

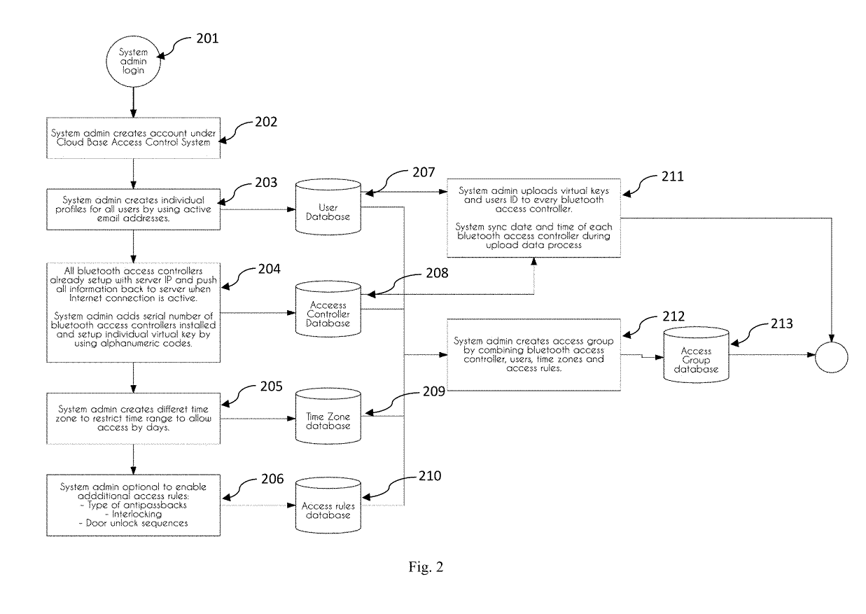

The system 100 operations in different embodiment of operation. One of the embodiment discloses the administrator operation as shown in FIG. 2. The system 100 allows the system administrator to access the cloud base server 110 anytime from anywhere by using the URL and login credentials. System administrator can handle the system on any OS platform, computing device and etc. Upon successful login 201 to the cloud base server 110, the system administrator can create user account 202, individual profiles for all users by using an active email 203 whereby all the user's information will be stored in a user database 207. Moving on, system admin can further setup an individual virtual key 204 for each user, whereby the virtual key will be stored in an access controller database 208. Furthermore, the system admin may also restrict the time range 205 to allow access by creating a different time zone in the time zone database 209. Additional access rules such as type of anti-passback, interlocking and door unlock sequences may also be configured within the admin account 206 and all this information will be stored in an access rules database 210. Upon the completion of administrative setup configuration in the cloud base server 110, the system admin will then combine the information such as BLUETOOTH access controller, users, time zone and access rules into a access group database 213.

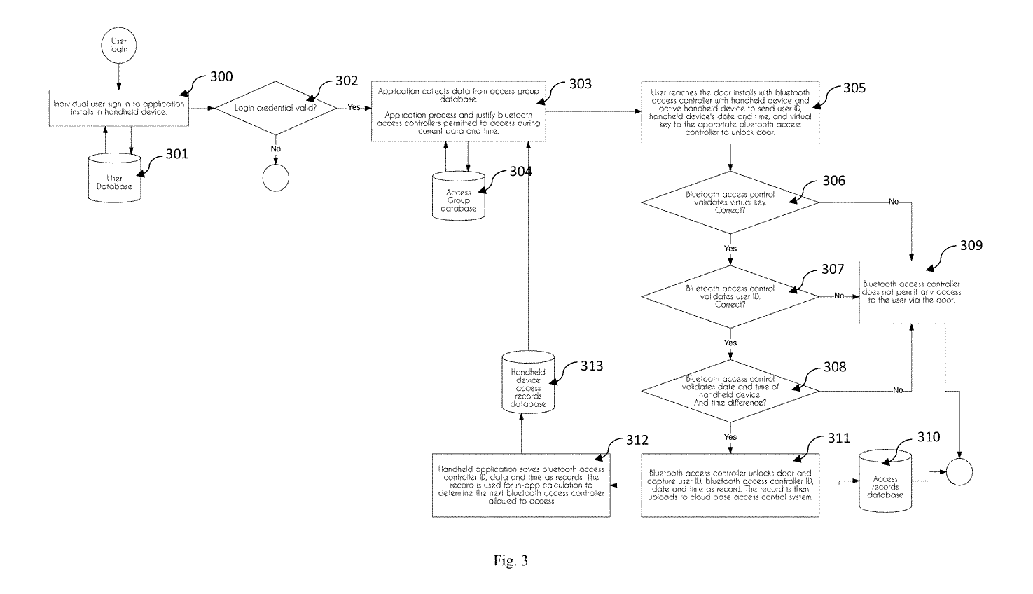

Another embodiment of the system 100 as illustrated in FIG. 3, whereby the user operation mode of the system is shown. The user operation mode starts with step 300 where a registered user sign in to the application installed in a handheld device 160 in which the application will refer to the user database 301 for validating the user identity 302. Next, in step 303 the application will then collect data from the access group database 304 for further processing and justifying the BLUETOOTH access controller permitted to access during current data and time. Followed by step 305, the user will then reach the door installed with the BLUETOOTH access controller with mobile device and send the user's access credentials such as user ID, mobile device's date and time, and virtual to the appropriate controller 140 for door unlocking. The controller 140 will then validate the virtual key 306, user ID 307, and date and time 308 of the mobile device 160 and denied the access 309 of the user if the any one of the credentials is not valid. Moving on in step 311, upon validation, the controller 140 unlocks the door and record the user's access in the access record database 310. On the other hand, the mobile device application will also save the controller's ID, date and time in the mobile device access record database 313 as a record 312 for the use of in-app calculation to determine the next BLUETOOTH access controller allowed to access.

On the other hand, the BLUETOOTH access controller 140 broadcasts its device ID via BLUETOOTH link 150 to the mobile device 160 such that the users are no longer required to activate the application in the mobile device before approaching the BLUETOOTH access controller 140. When a user with the mobile device 160 comes into the broadcasting range, the application captures the device ID and starts to compute the accessibility. The computing process can be referred in step 303 of FIG. 3 where the application will compare the device ID with Access Group Database 304 to justify the accessibility to the BLUETOOTH access control at the current date and time. If the user is permitted to access via this BLUETOOTH access controller 140, the application alerts the users by push notification method. User can read the on-screen message and tap on screen command button to instruct mobile device 160 to send unlock command to the BLUETOOTH access controller 140. By using the push notification method in mobile device 160, the step of signing in to the mobile application to send unlock door command can be neglected. However, the calculation operation is same as step 305 in FIG. 3. In another embodiment where the user is using wearable device such as smart watch, fitness tracking bands and smart glasses, the mobile device 160 can sync the information and message to the wearable device so that the users can perform the same operation on the wearable device without using the mobile device.

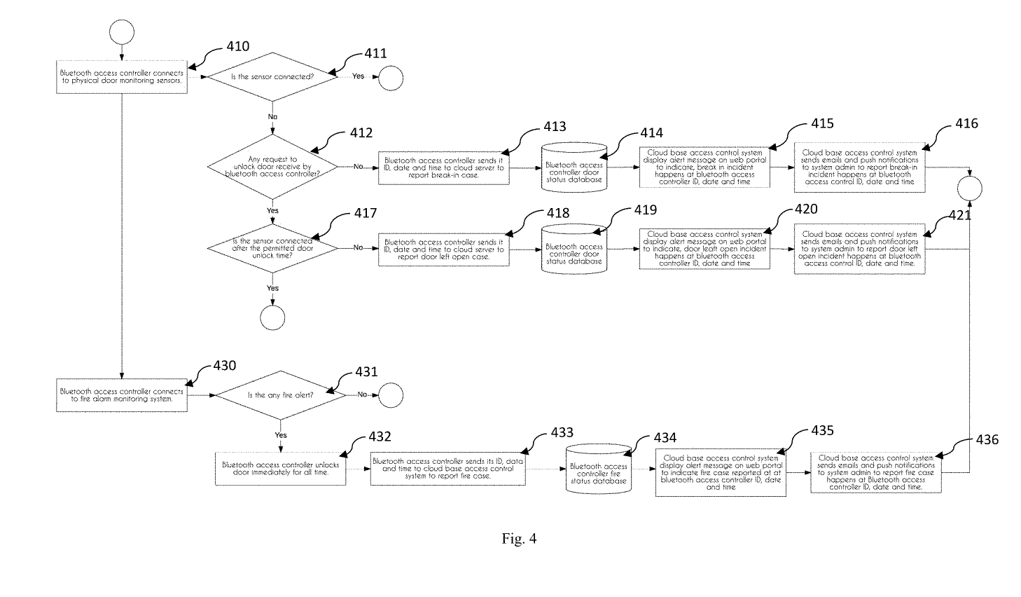

Furthermore, the BLUETOOTH access controller also includes security feature as shown in FIG. 4, wherein the controller is further connecting to a physical door monitoring sensor 410. In one of the preferred embodiment, the controller will perform a constant checking on the connection of the door sensors 411 and report a break-in case 413 to the server when the door is unlocked without authorization 412. The report will be sent to a BLUETOOTH access controller status database 414 for the server to display an alert message 415 on a web portal to indicate the break-in incident. The server will then sends emails and push notification 416 to system admin to report the break-in. In the second embodiment, the controller will perform a checking on the sensor connection for preventing door left open case 417. The controller will send a report 418 to the server if a door left open case is detected to the BLUETOOTH access controller door status database 419. The server will then gather the information from the database, display an alert message on the web portal 420 and lastly alert the system admin 421 by emails or push notifications. In the third embodiment which involves emergency case that happened within a building, the controller is further connected to a fire alarm monitoring system 430. When a fire alert is triggered 431, the controller will unlock the door 432 immediately for evacuation purpose. The fire case will then report by the controller to the server 433 and stores in the BLUETOOTH access controller fire status database 434. The server will further alert the administrator by displaying an alert message 435 and push notification sending 436.

On the other hand, the use of second layer of authentication in the controller 140, where the controller 140 performs checking on the user ID, date and time before the door access could be granted had minor the possibility of hijacking. In case system administrator restrict the user to access any door, but the user does not update the data in his mobile device 160. However, the changes already applied to all controllers 140, by removing the selected user ID to block access. This stops the user to access even his application in mobile device grant him access. When comes to access time control, user can change date and time of the mobile device 160. Thus, the controller 140 validates the date and time sent by the application in mobile device 160, to ensure time is synced.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. A control system for a door lock, comprising:
a server;
a controller for unlocking the door; and
a mobile device including:
an application for user to trigger a door unlocking process,
means for collecting biometric information of the user,
a BLUETOOTH module to establish a BLUETOOTH communication link between the mobile device and the controller;
wherein the controller is linked to the server to receive updates on user access credentials;
wherein the door unlocking process includes:
the mobile device firstly performs a biometric authentication to verify the user and then transmits an instruction to the controller (140) via the BLUETOOTH communication link; and
the controller upon receiving the instruction, performs a second authentication to verify the user's accessibility based on the received user access credentials and then unlock the door based on the outcomes of the authentications.

2. The system as claimed in claim 1, wherein the updates of user access credentials include user ID, date, time and controller pairing code.

3. The system as claimed in claim 2, wherein the controller performs the second authentication by checking the users' ID within a timeframe with the pre-stored authorized users' ID list before the door access could be granted.

4. The system as claimed in claim 3, wherein the server stores the user's access credentials.

5. The system as claimed in claim 4, wherein the server further processes the user's access credentials for the door unlocking process.

6. The system as claimed in claim 5, wherein the controller couples with an electronic door system and sensors for controlling the operation of the door.

7. The system as claimed in claim 6, wherein the controller tracks and reports door status to the server.

8. The system as claimed in claim 7, wherein the mobile device application receives user's access credentials from the server to perform local authentication.

9. The system as claimed in claim 8, wherein the biometric data collecting means is in the form of fingerprint sensor, face recognition sensor, iris sensor, body posture sensor or in any combination thereof.

10. A method for accessing a door entrance wirelessly via a mobile application, comprising the steps of:
authenticating, via means for collecting biometric information on a mobile device, a user's identity for triggering the door unlocking process;
transmitting, via a BLUETOOTH communication link, an instruction to the controller for door unlocking process;
connecting, via a network router, the controller to the server for receiving user access credentials;
receiving, from the server by the controller, updates on the list of authorized user ID in every predetermined time interval;
performing, via the controller, a second authentication based the updated list of authorized user ID to verify the user's accessibility; and
unlocking, via an electronic door system, the door for the access of the authorized users.

11. The method as claimed in claim 10, wherein the second authentication further includes the steps of checking the user access credential within a timeframe with a pre-stored user access credential within the controller.

12. The method as claimed in claim 10, wherein the biometric authentication is performed locally by the following steps of receiving user's access credential from the server via the mobile device.
